(19) United States
(12) Patent Application Publication
(10) Pub. No.: US 2001/0042007 A1
(43) Pub. Date: Nov. 15, 2001

(54) METHOD AND SYSTEM FOR CONTROLLING THE USE OF ANCILLARY SERVICE FACILITIES

(76) Inventor: DAVID B. KLINGLE, ST. PETERSBURG, FL (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/429,451

(22) Filed: Oct. 28, 1999

(51) Int. Cl. G06F 17/60

(52) U.S. Cl. 705/14

(57) ABSTRACT

A method, system and computer program component for allowing the controlled use of automated ancillary service facilities. Example ancillary service facilities include a car wash, automobile a vacuum cleaner and a compressed air dispenser. A provider of ancillary services associates credits with either a certificate that is given to a customer, or with an identification of the customer himself or herself. The customer presents the certificate or identification to automated reading equipment at the ancillary service facility and is allowed to use the facility if a credit has been associated with the presented item.

### BACKGROUND OF THE INVENTION

1. Field of the Invention

The present invention relates to ancillary service facilities and in particular, to automating the use of such facilities.

2. Discussion of the Background

Ancillary service facilities, which include automobile washing facilities, compressed air facilities and automobile vacuum cleaning facilities, are being installed in a variety of businesses in addition to their traditional presence in motor vehicle fueling stations. Motor vehicle fueling stations have provided these services to their customers. Some fueling stations charge their customers for use of these facilities and discount the charge for this use if the customer makes additional purchases at the fueling station. The convenience of use of ancillary motor vehicle service facilities, and their relatively low installation and maintenance costs, make them an attractive addition to many businesses.

Efforts to minimize the expense of operating automated automobile washing facilities have lead to a variety of innovations which facilitate their use by customers. U.S. Pat. No. 4,527,578 to Klein, et al. teaches using a code activated car wash wherein a customer is given a numerical code number to enter into a keypad at the entrance of the car wash. This system has the drawback that the user must manually type in the code number onto a keypad located near the entrance of the car wash while the customer is seated in his or her automobile. In addition, the document which contains the code number may be confusing, difficult to read, or the customer may lose the document.

U.S. Pat. No. 5,650,761 to Gomm, et al. teaches using a smart card as an alternative to money in conjunction with automatically delivered goods or services, such as an automatic car wash. This reference teaches storing a credit representing a cash balance and transferring the cash value from the smart card to a retailer's account.

### SUMMARY OF THE INVENTION

It is an object of the present invention is to provide control of ancillary service facilities.

It is another object of this invention to improve the techniques available to provide ancillary services as a promotional benefit.

It is another object of this invention to enable retailers to provide ancillary services to a person, depending upon demographics, transaction history, and other personal factors.

The present invention achieves these an further objectives by associating a credit for ancillary services with a token. Tokens used by the present invention are either a certificate given to a customer or a card containing a customer's identification. The token contains machine readable data which corresponds to data in a database indicating a credit and conditions precedent to obtaining the credit. The machine readable data may be a code identifying the credit and conditions. The machine readable data may be an identification code identifying the customer, such as a social security number. If the machine readable data is an identification code identifying the customer, then the aforementioned database stores the terms and conditions of a credit in association with that identification code. Since the customer may be uniquely identified by biometric data, such as finger prints or iris patterns, the customer's unique attributes may be used as a token by the present invention. Credits for the use of ancillary services are determined by machine reading the data contained in or on a token by methods including reading printed objects with bar codes, reading objects with magnetically encoded information, observations made by reading radio frequency devices or customer biometrics. The retailer associates a credit to use an ancillary service with a token and the ancillary service system reads the data on the token presented by the customer. The ancillary service facility system's control system determines whether to provide the ancillary service and accounting for the ancillary service depending upon the data read by the token.

### BRIEF DESCRIPTION OF THE DRAWINGS

FIG. 1 is an overhead view of a retailer's facility which includes facilities to provide ancillary services;

FIG. 2 is a front view of a printed certificate which comprises an optically readable bar code and which is also associated with a credit to use a car washing facility;

FIG. 3 is an front view of a retailer's frequent shopper's card which comprises an optically readable bar code;

FIG. 4 is an front view of a retailer's frequent shopper's card which comprises a magnetic stripe which contains magnetically encoded information;

FIG. 5 is a front view of an ancillary service facility user interface; and

FIG. 6 is a schematic diagram of the interconnection between the elements of the preferred embodiment of the present invention.

### DESCRIPTION OF THE PREFERRED EMBODIMENTS

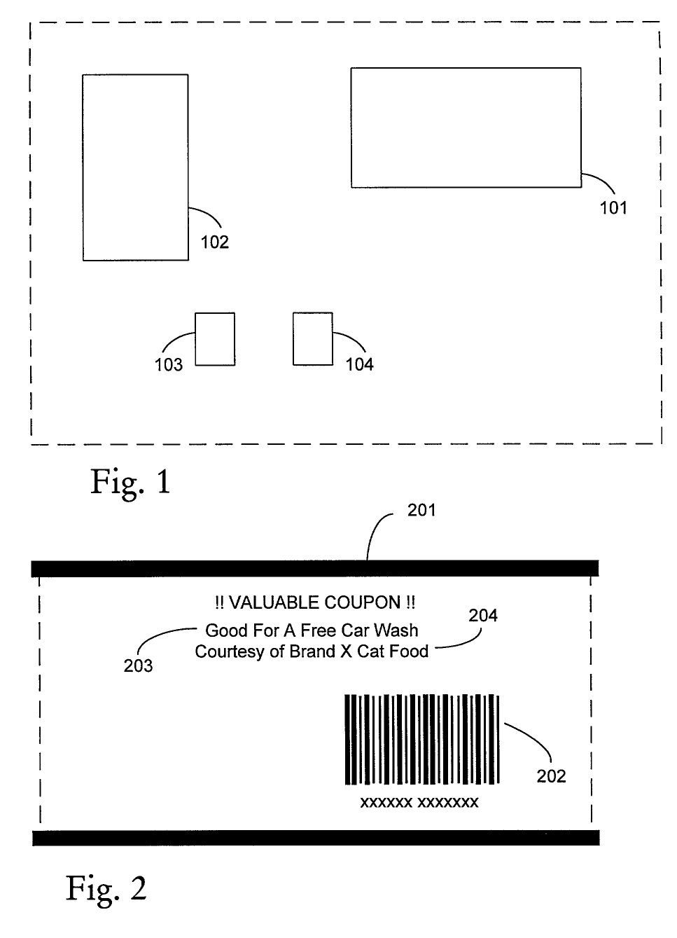

The description of the preferred embodiments will be made in conjunction with reference to the figures, wherein like numbered elements serve the same or similar functions. FIG. 1 illustrates a retailer which has a main building containing the retail store 101 which sells goods and/or non-ancillary services and which has nearby facilities to provide ancillary services. FIG. 1 shows the retail store 101 has the following ancillary facilities located in proximity to the store: a car wash 102, a compressed air dispenser 103 to allow customers to inflate tires or other objects requiring compressed air, and an automobile vacuum cleaner 104. The ancillary service facilities shown in FIG. 1 require a customer to provide payment for the facility or to identify that he or she has a credit to use the facility. The example retailer illustrated in FIG. 1 has the ancillary service facilities located near the retail store 101. A retailer could provide ancillary services at facilities which are located remotely from the retail store 101 or even through facilities near the retail store, but not operated by or owned by the retailer.

The present invention allows a retailer to selectively provide credits to customers for ancillary services. The existence of the credit is stored in a database along with data identifying the credit. The retailer either gives the customer a certificate containing machine readable data identifying the credit or stores the customer's identification in association with data identifying the credit. The system of the present invention uses an automated mechanism which reads the data identifying either the credit from the certificate or the customer's identification, determines if there exists a corresponding credit, provides the requested ancillary service, and accounts for the credit. Examples of certificates and customer identifications used by the present invention are shown in FIGS. 2 through 4 and are further described below.

Embodiments of the present invention may provide to the customer a certificate which represents the credit to use the ancillary service facility. Certificates issued to customers require an identification code, which is usually a unique number, to be encoded onto the certificate to allow identification of the certificate that is the token and determination of any credits that have been associated with that particular token. Each certificate will have an identification code encoded upon the certificate and this code may be either self authenticating or stored into a service credit database 501 and recalled for verification at the time of use, as is described below. A system and method for generating a self authenticating code number, which is a code number that appears to be random but is encoded so as to allow self-validation, that could be used as an identification number for certificates used by the present invention is disclosed in U.S. Pat. No. 5,892,827 to Beach. U.S. Pat. No. 5,892,827 and all references therein are hereby incorporated by reference.

FIG. 2 illustrates a printed certificate which is given to a customer who is entitled to use an ancillary service facility. FIG. 2 shows a certificate 201 which may be printed through the use of a receipt printer or special printer used to print such certificates. The certificate 201 may be printed at a Point Of Sale (POS) station, at an automated kiosk located within or away from a retail store, or by a terminal connected to the Internet or other electronic communication facility. The certificate 201 may also be provided in conjunction with a retail sales purchase either in response to a customer paying for the ancillary service or as part of a promotion sponsored by the retailer or other entity. The certificate 201 may contain a printed notice description 203 of the ancillary service to which the customer is entitled, a free car wash in the illustration. There may be an optional sponsor notice 204 of the entity which sponsors the customer's use of the ancillary service, brand “X Cat Food” in the illustration. A functional component of the certificate 201 is the printed bar code 202, which is encoded to contain the certificate's identification number and which will be scanned by equipment contained in the ancillary service facility to authorize the use of the facility.

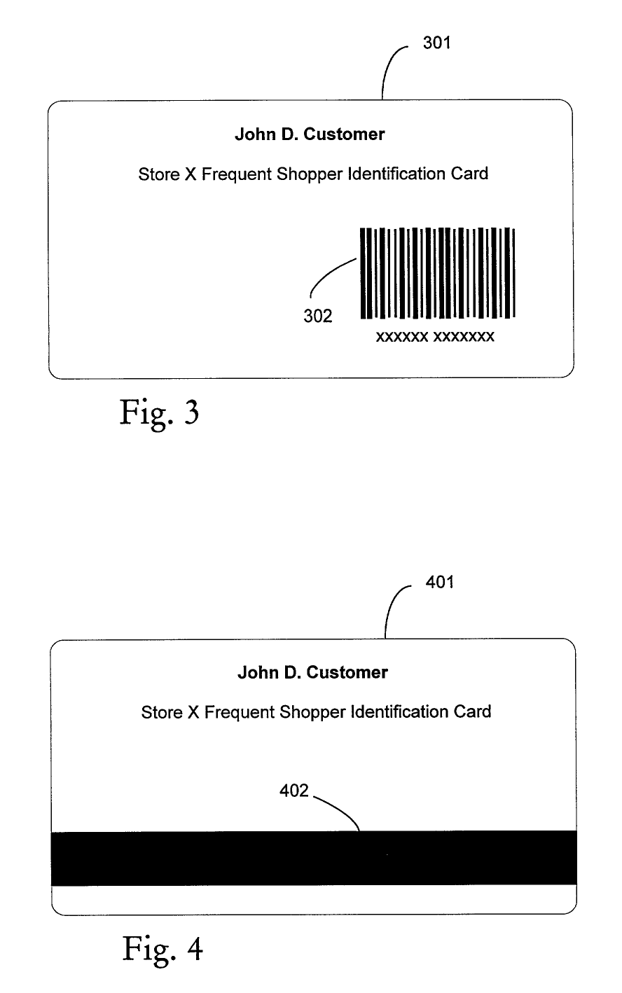

FIG. 3 illustrates a frequent shopper card 301 which may be used to identify the customer and may be used in conjunction with other promotions offered by a retailer. The frequent shopper card 301 may have the customer's name 301 printed upon the face of the card, although this is not a necessary element of this device. The frequent shopper card 301 contains a printed bar code 302 which contains an encoded number that uniquely identifies the card and correspondingly the customer whom holds the card. The present invention allows the retailer to associate a credit for the use of an ancillary service in association with the number encoded within the barcode 302 printed on the frequent shopper card 301. The customer presents his or her frequent shopper card 301 just prior to using the ancillary service and the ancillary service facility will determine if a credit for the use of the facility has been stored and allow the customer use of the service if a credit has been stored. Similar identification cards which contain an identifying bar code, such as a driver's license with a bar code, may also be used by the present invention.

The preferred embodiment of the present invention uses both the certificate 201 and frequent shopper card 301 as tokens presented to determine credits for the use of ancillary services. These devices are preferred because they are inexpensive to produce and equipment to read them are readily available and often already installed in retail stores. The use of a printed bar code also allows visual inspection of the encoded information to allow observation of gross misprinting of the certificate as well as indications of alteration.

FIG. 4 illustrates an alternative device which may be used as a certificate or customer identification by alternative embodiments of the present invention. FIG. 4 illustrates a card 401 which comprises a magnetic stripe 402 that contains encoded information which serves to identify the customer. The card 401 may be a certificate that is given to the customer and used in a manner similar to the certificate illustrated in FIG. 2. Identification data is encoded in the magnetic stripe 402 of the card 401. The card 401 may similarly be an alternative embodiment of a frequent shopper card, as defined in FIG. 3.

Alternative embodiments of the present invention may use a card 401 that is also a payment card, such as a credit card or debit card, used by the customer to pay for purchases. These embodiments of the present invention use the information magnetically encoded onto the magnetic stripe 402 on these payment cards only to identify the card, and thereby the customer, and do not charge the account associated with the card for the service.

A device similar to card 401 is a “SmartCard.” A SmartCard is a card which can be easily carried and which has multiple bytes of electronically readable memory. A SmartCard interfaces with a reader which will read the contents of the memory. The present invention may use a SmartCard by storing data in the SmartCard's memory that is equivalent to the code encoded into the bar code of certificate 201 or card 301/401. The SmartCard memory could also be programmed with a self authenticating code, as described above, or other information indicating the credit to use the ancillary service facility.

In addition to the tokens illustrated in FIGS. 2 through 4, it is obvious that the present invention may use the determination of any customer identification to identify the customer and support determination of credits that customers may have for ancillary services. Other customer identification processes which may be used include automated reading of a personal check to determine the customer's checking account number, determining a cellular telephone identification number by using an radio frequency query of a cellular phone used by the customer, querying Radio frequency “tag” identification devices held by the customer or measurement of the customer's biometrics including fingerprints, voice prints and other measurements known to practitioners in the relevant arts. Devices which are able to read these data and parameters are likewise known to practitioners of the relevant arts.

A customer's identification may be further determined by data the user enters at the ancillary service facility. The data entered may be an identification number or an identifier used in conjunction with an Internet service, as is described below.

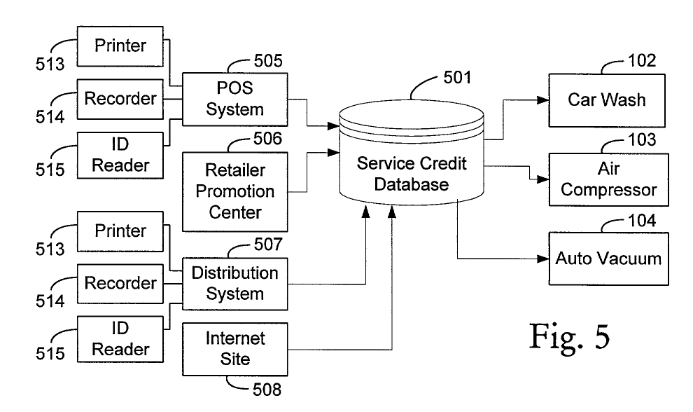

FIG. 5 illustrates a schematic diagram of the data processing elements of the preferred embodiment of the present invention. The service credit database 501 stores the ancillary service credits associated with either certificates or customer identification. The retailer provides credits to the benefit of a customer through a variety of crediting systems which store the credit in association with a token in the service credit database 501. FIG. 5 illustrates examples of crediting systems including Point Of Sale (POS) systems 505, distribution systems 507, retailer promotional systems 506 and Internet site 508.

The ancillary service facilities have a device which reads a certificate or customer identification presented at the ancillary service facility. The preferred embodiment of the present invention uses a bar code scanner which optically scans bar codes printed upon either a certificate 201 or a frequent shopper card 301, as described below. The ancillary service facilities have a controller, which in the preferred embodiment is an embedded computer programmed to control the operation of the facility and limit use of the facility, compares the presented token with data stored in the service credit database 501 to determine if the presented token is associated with a credit to use that service. The controller will then permit the use of the facility if the presented token has been associated with a credit. The preferred embodiment will store the identification number encoded within the bar code 202 or 302 in the service credit database 501 to indicate tokens with a credit. When a certificate 201 or frequent shopper card 301 is presented and the presenter uses the ancillary service facility, the credit is removed from the service credit database.

The example ancillary services illustrated in FIG. 5 include a car wash 102, a compressed air dispenser, 103 and an automobile vacuum cleaner 104. The POS station 505 and distribution station 507 may also have a printer 513 to print certificates or other notices to the customer or user of the equipment, a recorder 514 to record information onto magnetic stripes contained on cards if that is utilized by the particular embodiment and an optional ID reader 515 which will read the customer identification if the particular embodiment uses customer identification as a tokens.

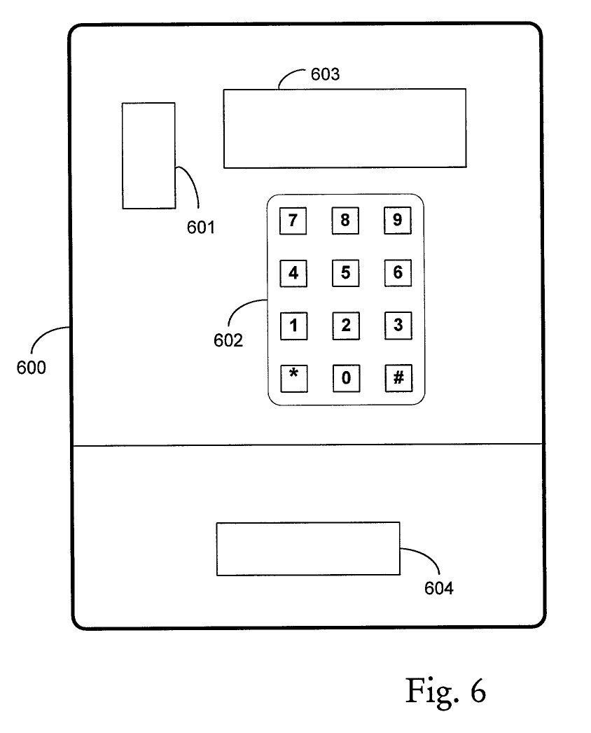

FIG. 6 illustrates a facility user interface 600 for the ancillary service facilities. The facility user interface 600 allows the customer to select options and control the operation of the facility as needed. The facility user interface 600 either accepts payment for use of the service or accepts a certificate or customer identification and determines if a credit has been associated with the presented certificate or customer identification. The facility user interface 600 comprises a display 603 to provide instructions or messages to the customer who is using the facility. Such displays may include instructions on the use of the facility user interface, identification of the cost of services available through the associated facility, and other information associated with the use of the facility user interface.

The facility user interface 600 further comprises a money acceptor 601 to allow the customer to pay for services. The money acceptor 601 may accept coins or currency to allow for payment for services to be provided. The money acceptor 601 will also return change to correct overpayment by the customer. A keypad 602 allows the customer to select options during the course of using the facility user interface.

The facility user interface 604 further comprises a certificate/ID reader 604 which will read the certificates or customer identification used by the particular embodiment. The certificate/ID reader of the preferred embodiment comprises a bar code scanner to read certificates or customer identification cards with printed bar codes. Embodiments of the present invention which use a certificate or customer identification that comprises a magnetic stripe will use an appropriate reader to read the information on the magnetic stripe. The certificate/ID reader 604 in embodiments which use a customer check number, cellular phone identification, radio frequency “tag” identification or measurement of customer's biometrics will use devices known to practitioners in the relevant arts to read these items and produce an electronically readable output for use as a token.

The operation of the present invention begins when the retailer associates a credit for an ancillary service with a token. A retailer may associate a credit with at token in response to a customer's payment for the ancillary service.

A retailer may also associate a credit with a token as part of a promotional program. Examples of such promotional programs include providing a credit to use an ancillary service in response to the purchase of a specified product. The promotional program may be a computer implemented promotional program depending a credit based upon a customer's prior purchase history or the relative frequency of the customer's purchase of certain products. The promotional program may provide a limited or unlimited number of credits to selected or all members of the retailer's frequent shopper program. The credit may be for one free use of an ancillary service, or a reduced cost use of the ancillary service.

FIG. 5 illustrates several facilities which will “give” a customer credit to use an ancillary service, i.e. facilities which cause a credit to be associated with a token either already possessed or to be given to the customer. The facilities used to give credit may be placed within retail stores such as supermarkets, fuel stations, department stores, and convenience stores. Credit for ancillary services may also be given in conjunction with a customer's interaction with an Internet site, such as a world wide web site.

One facility to give credit for an ancillary service is a Point Of Sale (POS) station 605. POS station 605 may be located at a checkout stand of a retailer or may be present at other sales locations. The POS station 505 may accept payment for the ancillary service, or the ancillary service may be given at a reduced price or cost free in response to the purchase of a specified item. The POS station 505 will either generate a certificate to give to the customer or read a customer's identification depending upon the particular embodiment. If a certificate is to be generated, a certificate identification code, to be encoded upon the certificate, may be selected by the POS station. If a printed certificate 201 is to be issued, the POS station may have a printer 513 to generate the certificate. If a certificate with a magnetic stripe is to be issued, a recorder 514 may be used to record the code onto the certificate. If a customer's identification is used as a token, the POS station 505 will contain a customer identification reader 515. The customer identification reader 515 will be able to read or allow entry of the form of customer identification used by the particular embodiment, as described above.

A specialized form of POS station includes a fuel pump located at a fuel sales facility that is used to dispense and sell fuel. A fuel pump which includes a suitable printer may be used to print a certificate 201 in response to a qualifying purchase of fuel. A fuel pump which further comprises an ID reader 515 may read the identification of the customer purchasing fuel and provide a credit for the use of an ancillary service facility to that customer based upon a qualifying purchase. Ancillary facility usage credits which are determined by the fuel pump located at a fuel sales facility will communicate data associated with the token representing the credit to the service credit database 501. A POS system which is either located in a retail store or part of a fuel pump may also comprise a keyboard or other mechanism to allow the customer to enter his or her identification data.

In addition to a POS station 505, a retailer may either distribute certificates or associate credit with a token based upon customer identification at a distribution station 506. Distribution station 506 operates in a manner similar to POS station 505, but does not handle the general checkout processing of the POS station 505. Embodiments of a distribution station 506 may simply include a device for accepting change or currency and that will issue a certificate 201 in response to a customer depositing currency of sufficient value to use the ancillary service. Distribution station 506 may also be embodied in an automated kiosk which is located at locations that are convenient for the customer to use. Distribution station 506 may provide certificates or give credits to customers for no cost or at a discount to encourage people to use the distribution station. These embodiments of a distribution station 506 may further read customer identification, as describe above, to determine the token with which to associate the credit for ancillary service.

Credit for the use of an ancillary service may also be given to customers or the public at large through a retailer promotion system 507. A retailer promotion system 507 provides credits to people who are not necessarily customers of the retailer providing the ancillary service and it may provide credits to people that have no interaction with the retailer in order to entice people to become customers. A retailer may define classes of people to receive credit to use ancillary services and the retailer promotion system 507 will determine the members of these classes and either give these class members credits to use ancillary services based upon their identification card or the retailer promotion system 507 may cause certificates to be distributed to these class members who may then use the certificates to receive the service. Classes of people to receive a credit for use of an ancillary device include people who live in a certain geographic area, people who are members of a frequent shopper club, customers of a retailer who have purchased a minimum value of products over a specified time period and other categories of people that a retailer would desire to entice to use the retailer's facilities. A class of people to be given credit to use an ancillary service may also be chosen based upon a machine readable identification accepted by the retailer, such as a frequent shopper card, payment card or checking account number. A class given a credit in association with a frequent shopper card or payment account and which is selected upon minimum purchase patterns that are also tracked through the use of the same frequent shopper card or payment account is a case where the class is chosen based upon the use of an identification device. Providing credit to all members of a retailer's frequent shopper club is another example of selecting a class of people based upon a machine readable identification. A retailer promotion system 507 may use the credit card number or frequent shopper club membership number as a token and associate a credit for an ancillary service with these tokens. A retailer promotion center may also distribute certificates to non-customers selected by geographic area of the person's residence or other factors. The certificates may be distributed by mail or communicated electronically through e-mail or equivalent media.

A retailer may also use an Internet site to associate credits with tokens. A retailer may have a world wide web site which allows customers to enter their frequent shopper club number, or indication of other machine readable identification (e.g. a credit card number that is encoded in a magnetic stripe on a credit card), as a token identifier and the Internet site 508 will associate that token with a credit for the use of an ancillary service. An Internet site 508 may also generate an image of a printed certificate 201 and cause the terminal connected to the Internet site to print the certificate, which may then be presented at an ancillary service facility as a token. A certificate may be printed at a terminal connected to a world wide web site by displaying a picture of the printed certificate 201 and instructing the terminal's user to use the print function of the world wide web browser to print the display. A world wide web site could also prompt a user to enter identification information associated with that user, such as a frequent shopper card, payment card or checking account number, and a credit could be associated with a token that corresponds to the provided identification information. In addition to providing information to print a certificate or associating a credit with a user's identification during the visit to an Internet site, the Internet site could also operate an automatic mailing or automatic electronic mailing facility which would automatically distribute periodic messages concerning credits given to prior users of the Internet site.

A retailer may utilize Internet based identifications to identify the customer at the ancillary service facility or at a retailer facility. Examples of Internet based identification which may be used by the present invention include allowing the customer to enter his or her e-mail address through a keyboard located at the ancillary service facility. A retailer may also utilize an Internet World Wide Web (WWW) site that incorporates personal web site pages for each customer. These personal WWW site pages are pages maintained for individual customers and each personal WWW site page has a Universal Resource Locator (URL) chosen to correspond to either the associated customer's name or other customer identification. These personal WWW site pages may be used to offer purchasing incentives to the customer as well as offer credits to use ancillary service facilities. The URL or other identification technique used to identify the personal WWW site page for an individual customer may also be used to identify the customer at the retailer facility or ancillary service facility. Identification through a personal WWW site page or e-mail account may be achieved by entering identification data through the use of a keyboard or by using a WWW browser or other Internet interface that is incorporated into the retail facility or ancillary service facility to reach the customer's personal WWW page or e-mail account and identification from this page or account may then be transferred from the browser interface to the ancillary service facility controller or used by the retail facility to identify the customer.

This description of the preferred embodiment describes ancillary services which are provided by a retailer. It is to be understood that the present invention may also be used to allow other product or service promoters to provide ancillary services as part of a promotional program. A system implementing the present invention may have the costs associated with the ancillary services paid for by a promoter. A promoter paying for some or all of the costs of the ancillary services may thereby be allowed to give a limited or unlimited number of credits to individuals allowing the individual to use the ancillary service. Promoters which may utilize the present invention in this manner include marketing organizations, such as a marketing agency promoting a product or category of products, a credit card company desiring to increase the use of their card, and other business entities that desire to provide ancillary services as a promotional enticement.

The use of the ancillary service facilities may be provided to the customer at either no cost or at a reduced cost. If the credit is not fully paid for by the customer, a third party sponsor may pay the amount by which the price is discounted in exchange for promotional consideration. The promotional consideration given to the sponsor may include a message printed upon a certificate given to the customer, the display 503 on the facility user interface 500 may display a message in association with accepting the token, or the ancillary service facility may have general advertising by the sponsor. Promotional consideration may also be advertising posted on or near the POS system 505, distribution system 507 or on the display of an Internet terminal generated by the Internet site 508.

Providing credits to use ancillary services may also be used as an incentive for the customer to make purchases from a retail facility, encourage the use of a frequent shopper club card, or to encourage the purchase of a specified product or combination of products.

A retailer with a frequent shopper club program, which requires that a frequent shopper club identification card be read at customer checkout to receive benefits, may track the frequency of visits that a particular customer makes to the store. This allows the retailer to provide ancillary service facility usage credits, at either no costs or at reduced costs, to customers based upon their frequency of shopping visits. If a customer makes frequent shopping visits to the retailer, the retailer may wish to reward the customer with credits to use ancillary services at no cost, or to provide credits at a discount not available to less frequent shoppers. This benefit will also serve to further encourage customers to use their frequent shopper card during every visit. A similar benefit may be extended to infrequent shoppers in order to entice them to make more shopping visits. Shopper frequency may also be tracked by other customer identifications, including credit cards, checking account numbers of checks used to pay for purchases, as well as other identifiers.

A retailer or product promoter could provide a customer ancillary service usage credits in response to the customer's purchase of a specified item, a specified combination of items or a total purchase amount. The POS system 505 may be configured to recognize a customer's purchase of a specified item or combination of items and to either print a certificate on printer 513, which will also require the identification number encoded within bar code 202 to be stored into the service credit database 501, or add a credit in association with a frequent shopper's account number, as determined by reading the bar code 302 on the purchaser's frequent shopper card 201, into service credit database 501. A credit for the use of an ancillary service facility may also be provided to a shopper for purchasing merchandise or services in excess of a specified amount. Giving a customer a credit for the use of an ancillary service facility in response to a customer's purchase of a specified product, combination of products or a minimum total purchase amount may be further conditioned upon the customer's use of a frequent shopping card in association with that purchase. The credits provided in exchange for qualifying purchases may be sponsored, i.e. paid for, by either by the retailer or by a manufacturer. Manufacturers may use the present invention to sponsor promotions that provide ancillary services to customers who purchase one or a specified number of their products. The sponsor of the credit may be indicated on a certificate by the printed notice 203 or if a credit is associated with a customer's identification, a printed notice may still be produced by printer 513 and given to the customer to inform him or her of the credit provided as well as inform him or her of the sponsor of the credit.

It is obvious that numerous modifications and variations of the present invention are possible in light of the above teachings. It is therefore to be understood that within the scope of the appended claims, the invention may be practiced otherwise than as specifically described herein.

I claim:

1. A method for providing controlled use of an ancillary service facility associated with a retail store, comprising the steps of:
storing in a database a first identification in association with data defining a credit for use of an ancillary service facility;
generating a determination by determining if a second identification read by an ancillary service facility from a token matches said first identification; and
depending use of said ancillary service facility based upon said determination.

2. A method as set forth in claim 1, wherein said ancillary service facility is a car wash.

3. A method as set forth in claim 1, wherein said ancillary service facility is a compressed air dispenser.

4. A method as set forth in claim 1, wherein said ancillary service facility is a vacuum cleaner.

5. A method as set forth in claim 1, wherein said step of storing is performed in response to data received from a retail sales facility.

6. A method as set forth in claim 1, wherein said step of storing is performed in response to data received from a fuel sales facility.

7. A method as set forth in claim 1, wherein said step of associating is performed at an automated kiosk.

8. A method as set forth in claim 1, wherein said step of storing is performed in response to data received from an Internet site.

9. A method as set forth in claim 8, wherein said Internet site is a automated e-mail facility.

10. A method as set forth in claim 8, further comprising the step of communicating an indication of said first token through electronic communications.

11. A method as set forth in claim 10, wherein said step of communicating comprises the step of a customer's providing an indication of said first identification to said Internet site.

12. A method as set forth in claim 10, further comprising the step of communicating data describing a token to a user of said Internet site.

13. A method as set forth in claim 12, wherein said token is a coupon printed by an Internet terminal.

14. A method as set forth in claim 1, wherein said step of storing is performed in response to a customer's membership in a frequent shopper's club, wherein said customer is associated with said first identification.

15. A method as set forth in claim 1, wherein said token is a printed coupon and said second identification is encoded within a barcode.

16. A method as set forth in claim 15, wherein said step of generating a determination comprises reading said barcode.

17. A method as set forth in claim 15, wherein said barcode contains a self authenticating identification.

18. A method as set forth in claim 1, wherein said token is a frequent shopper card and said second identification is encoded within one of
a printed barcode, and
a magnetic stripe.

19. A method as set forth in claim 1, wherein said token is a smart card and said second identification is encoded within said smart card.

20. A method as set forth in claim 1, wherein said first identification is a customer telephone number and wherein said step of generating a determination comprises manually entering said customer telephone number.

21. A method as set forth in claim 1, wherein said token is a radio frequency identification device and said step of generating a determination comprises reading said radio frequency identification device.

22. A method as set forth in claim 1, wherein said token is a radio telephone and said step of generating a determination comprises reading a transmitted identification from said radio telephone.

23. A method as set forth in claim 1, wherein said token is an Internet based identification and said step of generating a determination comprises determining said Internet based identification.

24. A method as set forth in claim 23, wherein said Internet based identification comprises a Universal Resource Locator associated with an individual.

25. A method as set forth in claim 23, wherein said Internet based identification comprises an e-mail account associated with an individual.

26. A method as set forth in claim 23, wherein said step of step of generating a determination comprises determining said internet based identification by an individual's operation of an associated Internet interface.

27. A method as set forth in claim 1, wherein said first identification is a payment account number and said step of generating a determination comprises determining said payment account number.

28. A method as set forth in claim 23, wherein said payment account number is associated with a credit card and said second identification is encoded into a magnetic stripe contained on said credit card.

29. A method as set forth in claim 23, wherein said payment account number is associated with a checking account and said step of generating a determination comprises reading an account number of said checking account.

30. A method as set forth in claim 1, wherein said step of storing is performed in response to a use of an Internet site.

31. A method as set forth in claim 26, wherein said Internet site is a World Wide Web site.

32. A method as set forth in claim 1, wherein said step of storing is performed in response to a retail purchase from said retail store by a customer associated with said first identification.

33. A method as set forth in claim 28, wherein said step of storing is performed in response to an ancillary service use credit purchase, wherein said ancillary service use credit purchase is discounted by a promotional amount.

34. A method as set forth in claim 29, wherein a sponsor pays said promotional amount.

35. A method as set forth in claim 30, wherein said token contains information identifying said sponsor.

36. A method as set forth in claim 30, wherein a notice identifying said sponsor is provided to said customer.

37. A method as set forth in claim 30, wherein said sponsor is a product manufacturer.

38. A method as set forth in claim 30, wherein said sponsor is a promotional agency.

39. A system for providing controlled use of an ancillary service facility, comprising:
means for storing in a database a first identification in association with data defining a credit for use of an ancillary service facility;
means for generating a determination by determining if a second identification read by an ancillary service facility from a token matches said first identification; and
a controller for permitting use of said ancillary service facility based upon said determination.

40. A system as set forth in claim 35, wherein said ancillary service facility is a car wash.

41. A system as set forth in claim 35, wherein said ancillary service facility is a compressed air dispenser.

42. A system as set forth in claim 35, wherein said ancillary service facility is a vacuum cleaner.

43. A system as set forth in claim 35, wherein means for storing operates in response to data received from a retail sales facility.

44. A system as set forth in claim 35, wherein said means for storing operates in response to data received from a fuel sales facility.

45. A system as set forth in claim 35, wherein said means for storing operates in response to data received from an automated kiosk.

46. A system as set forth in claim 35, wherein said means for storing operates in response to data received from an Internet site.

47. A system as set forth in claim 42, wherein said Internet site is an automated email facility.

48. A system as set forth in claim 42, further comprising means for communicating an indication of said first token through electronic communications.

49. A system as set forth in claim 44, wherein said means for communicating comprises a means for accepting a customer account number operating in conjunction with said Internet site.

50. A system as set forth in claim 44, further comprising means for of communicating data describing a token to a user of said Internet site.

51. A system as set forth in claim 46, wherein said token is a coupon printed by an Internet terminal.

52. A system as set forth in claim 35, wherein said means for storing operates in response to a determination that a customer's associated with said first identification is a member of a frequent shopper's club.

53. A system as set forth in claim 35, wherein said token is a printed coupon and said second identification is encoded within a barcode.

54. A system as set forth in claim 49, wherein said means for generating a determination comprises means for optically reading said barcode.

55. A system as set forth in claim 49, wherein said barcode contain a self authenticating identification.

56. A system as set forth in claim 35, wherein said token is a frequent shopper card, respectively, and said second identification is encoded within one of:
a printed barcode, and
a magnetic stripe.

57. A system as set forth in claim 35, wherein said token is a smart card and said second identification is encoded within said smart card.

58. A system as set forth in claim 35, wherein said token is a customer telephone number and said means for generating a determination comprises a keypad allowing manual entry of said customer telephone number.

59. A system as set forth in claim 35, wherein said token is a Radio Frequency Identification device and said means for generating a determination comprises a Radio Frequency Identification device interrogator configured to read said Radio Frequency Identification device.

60. A system as set forth in claim 35, wherein said token is a radio telephone and said means for generating a determination comprises a radio transceiver configured to read a transmitted identification from said radio telephone.

61. A method as set forth in claim 1, wherein said token is an Internet based identification and said step of generating a determination comprises determining said Internet based identification.

62. A method as set forth in claim 23, wherein said Internet based identification comprises a Universal Resource Locator associated with an individual.

63. A method as set forth in claim 23, wherein said Internet based identification comprises an e-mail account associated with an individual.

64. A method as set forth in claim 23, wherein said step of step of generating a determination comprises determining said internet based identification by an individual's operation of an associated Internet interface.

65. A system as set forth in claim 35, wherein said token contains a payment account number and said means for generating a determination comprises means for determining said payment account number.

66. A system as set forth in claim 57, wherein said token is a credit card and said second identification is a number encoded within a magnetic stripe on said credit card.

67. A system as set forth in claim 57, wherein said token is a check and said second identification is a checking account number encoded within said check.

68. A system as set forth in claim 35, wherein said means for storing operates in response to a use of an Internet site.

69. A system as set forth in claim 60, wherein said Internet site is a World Wide Web site.

70. A system as set forth in claim 35, wherein said means for storing operates in response to a retail purchase from said retail store by a customer associated with said first identification.

71. A system as set forth in claim 62, wherein said means for storing operates in response to an ancillary service use credit purchase, wherein said ancillary service use credit purchase is discounted by a promotional amount.

72. A system as set forth in claim 63, wherein a sponsor pays said promotional amount.

73. A system as set forth in claim 64, wherein said token contains information identifying said sponsor.

74. A system as set forth in claim 64, further comprising means for providing a notice identifying said sponsor to said customer.

75. A system as set forth in claim 64, wherein said sponsor is a product manufacturer.

76. A system as set forth in claim 64, wherein said sponsor is a promotional agency.

77. A system for providing controlled use of an ancillary service facility, comprising:
a database storing a first identification in association with data defining a credit for use of an ancillary service facility;
a customer identification reader operating to read a second customer identification means for generating a determination by determining if a second identification read by an ancillary service facility from a token matches said first identification; and
a controller for permitting use of said ancillary service facility upon a determination that said second customer identification matches said first identification.

78. A computer program component for providing controlled use of an ancillary service facility, comprising:
a first computer program component configured to store into a database a first identification in association with data defining a credit for use of an ancillary service facility;
a second computer program component configured to generate a determination by determining if a second identification read by an ancillary service facility from a token matches said first identification; and
a third computer program component configured to permit use of said ancillary service facility based upon said determination.
